(19) United States
(12) Patent Application Publication
(10) Pub. No.: US 2018/0284432 A1
(43) Pub. Date: Oct. 4, 2018

(54) DRIVING ASSISTANCE DEVICE AND METHOD

(71) Applicant: BOE Technology Group Co., Ltd., Beijing (CN)

(72) Inventor: Wei Wei, Beijing (CN)

(21) Appl. No.: 15/511,190

(22) PCT Filed: May 25, 2016
(86) PCT No.: PCT/CN16/83240

§ 371 Date: Jun. 13, 2018

(30) Foreign Application Priority Data
Feb. 4, 2016 (CN) 201610079653.2

(51) Int. Cl. G02B 27/01; B60K 35/00

(52) U.S. Cl. CPC G02B 27/0101; B60K 35/00; B60K 2350/1084; B60K 2350/2052; G02B 2027/014; G02B 2027/0134; G02B 2027/0129; G02B 2027/0141; B60K 2350/965

(57) ABSTRACT

A driving assistance device and a driving assistance method applied in a vehicle are disclosed in the present disclosure. The driving assistance device includes: an identification module configured to identify a warning object ahead of the vehicle and a positional relationship between the warning object and the vehicle; an application module configured to determine warning information corresponding to the warning object, and generate a projection image in accordance with the warning information; a processing module configured to determine a projection position of the projection image in a projection area and a perceived distance between a formed image projected by the projection image to the projection area and a viewer in the vehicle, in accordance with the positional relationship between the warning object and the vehicle; and a projection module configured to project the warning information in accordance with the determined projection position and the determined perceived distance.

### CROSS-REFERENCE TO RELATED APPLICATIONS

The present application claims priority to Chinese Patent Application No. 201610079653.2, filed Feb. 4, 2016, the entire contents of which are incorporated herein by reference.

### TECHNICAL FIELD

The present disclosure relates to the field of display applied in a vehicle, and more particularly to a driving assistance device and a driving assistance method.

### BACKGROUND

In order to improve a convenience of a driver, a vehicle may be provided with a head-up display (HUD) for displaying information to the driver. The information displayed by the HUD can be projected onto a windshield of the vehicle to present the information in the driver’ field of view while the driver is driving. By displaying the information in the driver’ field of view, the driver does not have to leave a line of sight off the windshield (e.g., toward an instrument display on a central dashboard) while driving to view the presented information.

The HUD may present vehicle information, such as information relating to a speed of the vehicle, fuel level, engine temperature, etc., that is typically displayed in the vehicle's central dashboard. In addition, the HUD may present map information and communication events (e.g., navigation instructions, driving instructions, warnings, alarms, etc.) to the driver. The HUD of the vehicle may present information to the driver in a manner similar to that employed in the vehicle dashboard, such as by means of an instrument and a text box appearing as graphic elements on the windshield. In addition, the HUD of the vehicle may present a realistic graphic element that enhances a physical environment surrounding the vehicle using real-time information.

However, the HUD in the related art is designed according to a fixed imaging distance, thus a distance from a virtual image displayed by an image source through an optical display system in front of the human eye to the human eye is fixed. However, the environment in which the monitor is located changes at all times, and the images of the fixed imaging distance seen through such display systems are separated from the actual environment, resulting in a decrease in the quality of the user experience.

### SUMMARY

An object of the present disclosure is to solve the problem that a head-up display technique of a vehicle in the related art cannot integrate an image display of warning information with an actual environment of the vehicle.

In order to achieve the above object, in an aspect, some embodiments of the present disclosure provide a driving assistance device, applied in a vehicle having a projection area, the driving assistance device including:

an identification module configured to identify a warning object ahead of the vehicle and a positional relationship between the warning object and the vehicle;

an application module configured to determine warning information corresponding to the warning object, and generate a projection image in accordance with the warning information;

a processing module configured to determine a projection position of the projection image in a projection area and a perceived distance between a formed image projected by the projection image to the projection area and a viewer in the vehicle, in accordance with the positional relationship between the warning object and the vehicle; and

a projection module configured to project the warning information in accordance with the determined projection position and the determined perceived distance.

Optionally, an image of the warning information projected by the projection module includes:

a first image corresponding to a left eye of the viewer and a second image corresponding to a right eye of the viewer, and a projection position of the first image in the projection area is different from a projection position of the second image in the projection area.

Optionally, the driving assistance device further comprises:

stereoscopic glasses configured to assist the viewer to converge the first image and the second image to form a stereoscopic image.

Optionally, the positional relationship between the warning object and the vehicle includes a vertical distance of the warning object relative to the vehicle in a traveling direction of the vehicle.

The processing module determines the perceived distance of the viewer for the formed image projected by the warning information in accordance with the vertical distance, wherein the perceived distance is proportional to the vertical distance.

Optionally, the projection module includes:

a computing unit configured to determine a parallax between the first image and the second image projected by the projection module in accordance with the perceived distance; and

a projection unit configured to project the warning information in accordance with the determined parallax between the first image and the second image.

Optionally, the processing module is further configured to simulate a line-of-sight direction of the viewer viewing warning object in accordance with the positional relationship between the vehicle and the warning object, and determine an intersection of the line-of-sight direction and the projection area as the projection position of the projection image in the projection area.

In another aspect, some embodiments of the present disclosure provide a driving assistance method, applied in a vehicle having a projection area, the driving assistance method including:

identifying a warning object ahead of the vehicle and a positional relationship between the warning object and the vehicle;

determining warning information corresponding to the warning object, and generating a projection image in accordance with the warning information;

determining a projection position of the projection image in a projection area and a perceived distance between a formed image projected by the projection image to the projection area and a viewer in the vehicle in accordance with the positional relationship between the warning object and the vehicle; and

projecting the warning information in accordance with the determined projection position and the determined perceived distance.

Optionally, an image formed by projecting the warning information includes:

a first image corresponding to a left eye of the viewer and a second image corresponding to a right eye of the viewer, and a projection position of the first image in the projection area is different from a projection position of the second image in the projection area.

Optionally, the first image and the second image are converged to form a stereoscopic image by the viewer using a pair of stereoscopic glasses.

Optionally, the positional relationship between the warning object and the vehicle includes a vertical distance of the warning object relative to the vehicle in a traveling direction of the vehicle;

determining the perceived distance of the viewer for a formed image projected by the warning information in accordance with the positional relationship between the warning object and the vehicle includes:

determining the perceived distance of the viewer for the formed image projected by the warning information in accordance with the vertical distance, wherein the perceived distance is proportional to the vertical distance.

Optionally, projecting the warning information in accordance with the determined projection position and the determined perceived distance includes:

determining a parallax between the first image and the second image projected by the projection module in accordance with the perceived distance; and

projecting the first image and the second image in accordance with the determined parallax between the first image and the second image.

Optionally, the parallax between the first image and the second image is computed as:

$$A = B - \frac{B \times H}{S} ;$$

wherein, A is the parallax between the first image and the second image; B is a pupil distance of the viewer; H is a distance between the projection area and a center of two eyes of the viewer; and S is the perceived distance.

Optionally, the warning object includes a road element ahead of the vehicle and/or an object ahead of the vehicle;

wherein the warning information of the road element includes navigation information of the vehicle for the road element, and the warning information of the object ahead of the vehicle includes movement information of the object ahead of the vehicle.

Optionally, determining the projection position of the projection image in the projection area in accordance with the positional relationship between the warning object and the vehicle includes: simulating a line-of-sight direction of the viewer viewing warning object in accordance with the positional relationship between the vehicle and the warning object, and determining an intersection of the line-of-sight direction and the projection area as the projection position of the projection image in the projection area.

The above technical solutions of the present disclosure have the following advantageous effects.

The scheme of the present disclosure enhances the display effect of the image. The projection image of the warning information is integrated with the actual environment on side of the warning object outside the vehicle, such that the driver can see the corresponding warning information in the vicinity of the position of the warning object. Therefore, the display is more intuitive, thereby avoiding the attention of the driver from distracting when driving, and improving driving safety to a certain extent.

### BRIEF DESCRIPTION OF THE DRAWINGS

FIG. 1 is a schematic diagram of a structure of a driving assistance device of the present disclosure;

FIG. 2 is a schematic diagram of a principle of a driving assistance device of the present disclosure;

FIG. 3 is a schematic diagram of determining a positional relationship between a warning object and a vehicle of the present disclosure;

FIG. 4 is a schematic diagram of a relationship of a perceived distance and a parallax of a projection image of warning information of the present disclosure; and

FIG. 5 is a schematic diagram of displaying of a projection image of warning information of the present disclosure.

### DETAILED DESCRIPTION

In order that the technical problems to be solved by the present disclosure, the technical solutions and the advantages become more apparent, the present disclosure will be described below in detail with reference to the accompanying drawings and specific embodiments.

In the head-up display technique of the related art, since a projection position and a perceived distance of a projection image of warning information are fixed, the driver cannot visually determine the warning object indicated by the warning information, although it is convenient for the driver to observe the warning information. For example, when the driver sees speed limit information in a projection area, the driver needs to further confirm that which intersection ahead is indicated by the speed limit information, which cannot bring much help to the driver, especially in a complex road environment.

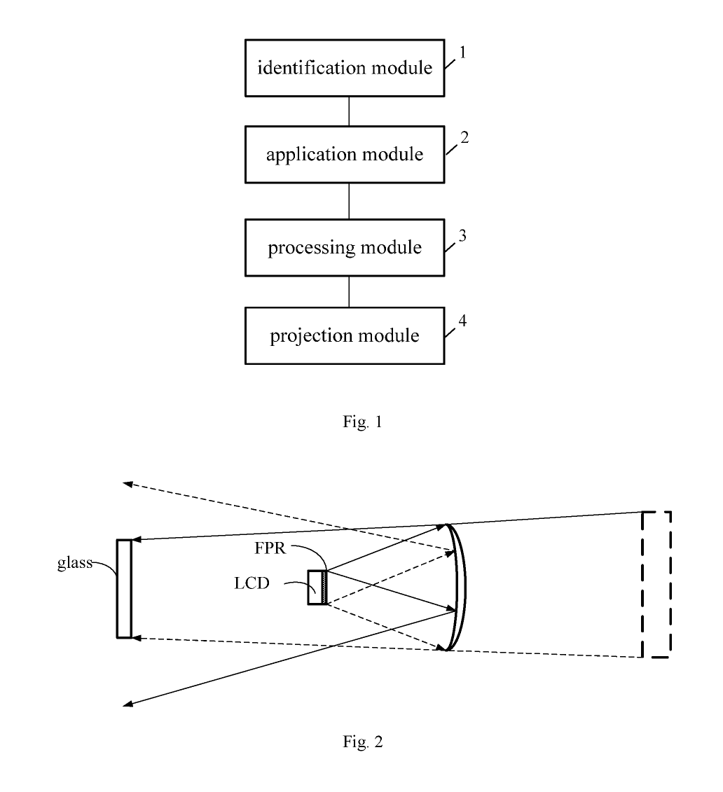

In an aspect, as shown in FIG. 1, some embodiments of the present disclosure provide a driving assistance device applied in a vehicle, and the driving assistance device includes an identification module 1, an application module 2, a processing module 3 and a projection module 4.

The identification module 1 is configured to identify a warning object ahead of the vehicle and a positional relationship between the warning object and the vehicle.

As an example, the warning object may be a road sign, an object (such as a person, another vehicle, or a barrier), a road element (such as a road, a road exit, or a road entrance) ahead of the vehicle, and the like.

The above identification module can be composed of a sensor and a processing chip. The sensor captures position data of the warning object. The processing chip selects the positional relationship between the warning object and the vehicle based on the position data.

The application module 2 is configured to determine warning information corresponding to the warning object, and generate a projection image in accordance with the warning information.

In specific practical application, if the warning object is a road sigh on the road, the application module can identify an image of the road sigh, determine content reminded on the road sign, and use the content reminded on the road sign as the warning information. If the warning object is a person or other vehicles, the application module can use movement information (such as moving speed or moving direction) of the person or other vehicles as the warning information. If the warning object is a road element (such as a road or an intersection light), the application module can use navigation information corresponding to the road element as the warning information.

The processing module 3 is configured to determine a projection position of the projection image in a projection area and a perceived distance between a formed image projected by the projection image to the projection area and a viewer in the vehicle, in accordance with the positional relationship between the warning object and the vehicle.

Since the projection position of the projection image and the perceived distance for the driver are determined by the position of the warning object relative to the vehicle, some embodiments of the present disclosure may display the projection image on the outside of the windshield of the vehicle near the position of the warning object, such that the projection image is integrated into the environment near the warning object.

The projection module 4 is configured to project the warning information in accordance with the determined projection position and the determined perceived distance.

In contrast to the related art, the driving assistance device of some embodiments of the present disclosure enhances the display effect of the image. The projection image of the warning information is integrated with the actual environment on side of the warning object outside the vehicle, such that the driver can intuitively determine the warning information and the corresponding warning object when seeing the warning information, thereby avoiding the attention of the driver from distracting when driving, and improving driving safety to a certain extent.

Further, the driving assistance device of some embodiments of the present disclosure can stereoscopically image the warning information. That is, the projection image of the warning information output by the projection module is polarized light, and the projection image includes a first image corresponding to a left eye of the driver and a second image corresponding to a right eye of the driver.

In the projection area, the projection position of the first image is different from the projection position of the second image. The driver can wear stereoscopic glasses, such that the first image recognized by the left eye and the second image recognized by the right eye may be converged to form a stereoscopic image of the warning information.

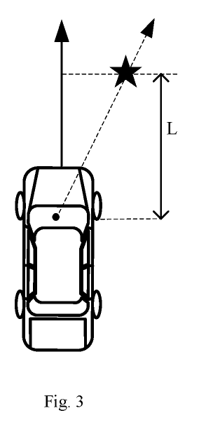

As an example, in practical application, as shown in FIG. 2, the projection device of some embodiments of the present disclosure may be a LCD display device. A light emitting side of the LCD display device for projecting is provided with a FPR (film-type patterned retarder, i.e., a 3D presentation manner) film, which may be used to convert the light projected by the LCD display device into the light of the first image and the light of the second image, which has different polarization directions. In FIG. 2, the solid arrow indicates a direction of the light of the first image, and the dashed arrow indicates a direction of the light of the second image. The light projected by the LCD device is finally reflected in the projection area (a crescent shape in FIG. 2) which equivalently has a mirror or concave mirror effect. The user receives the light reflected by the projection area by wearing stereoscopic glasses, and finally observes the stereoscopic image represented by a dotted rectangle as shown in FIG. 2.

It is to be noted here that, in some embodiments of the present disclosure, the light emitting side of the LCD display device for projecting may also be provided with a liquid crystal cell. Liquid crystal molecules of the liquid crystal cell may be controlled by a driving unit to be deflected to form a polarization effect equivalent to the FPR film. The projection method of the warning information is described below in detail.

Further, in some embodiments of the present disclosure, as shown in FIG. 3, determining the positional relationship between the warning object and the vehicle by the identification module includes: determining a vertical distance L of the warning object (i.e., a pentagram in FIG. 3) relative to the vehicle in a traveling direction of the vehicle.

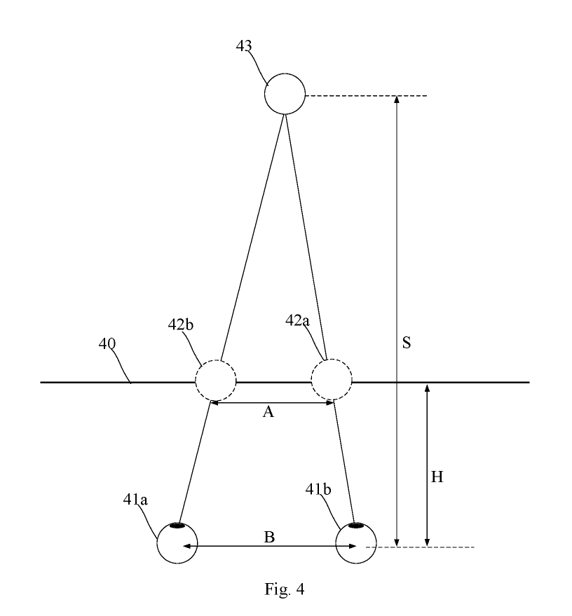

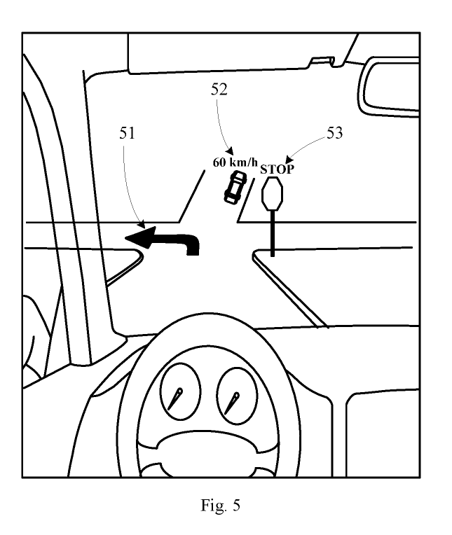

The processing module determines the perceived distance S (see FIG. 4) of the driver for a formed image projected by the warning information in accordance with the vertical distance L. The perceived distance S is proportional to the vertical distance described as above. That is, if the warning object is farther away from the vehicle in the traveling direction of the vehicle, the perceived distance of the driver for the warning information is farther accordingly. On the contrary, if the warning object is closer to the vehicle in the traveling direction of the vehicle, the perceived distance of the driver for the warning information is closer accordingly.

On the basis of the above, the projection module of some embodiments of the present disclosure further includes:

a computing unit configured to determine a parallax between the first image and the second image projected by the projection module in accordance with the perceived distance S; and

a projection unit configured to project the warning information in accordance with the determined parallax between the first image and the second image. As an example, referring to FIG. 4, a pupil distance between a left eye 41a and a right eye 41b of a user is B, a horizontal line 40 indicates a position of the projection area, H indicates a distance between the projection area and a center of two eyes of the driver, and A indicates a parallax of the user for the first image 42a and the second image 42b. It can be seen from FIG. 4 that the parallax A is a negative value. The stereoscopic glasses converges the first image and the second image having the negative parallax, and the user can observe a stereoscopic image 43 of the warning information outside of the projection area. In FIG. 4, S indicates the perceived distance of the user for the stereoscopic image 43.

According to the triangle theorem, it can be known that AB=(S−H)/S, wherein S, H, and B are known. Thus, the value of the parallax when the first image and the second image are projected can be determined, and the projection unit performs projecting in accordance with such parallax, such that the user can view the stereoscopic image outside of the windshield by using the stereoscopic glasses.

In the course of traveling, the positional relationship between the warning object and the vehicle is constantly changed, while some embodiments of the present disclosure only need to constantly adjust the parallax, the projection image can be adaptively displayed in the vicinity of the position of the warning object. Since the parallax changing technique is very simple in the implementation of the projection device in the related art, the position of the projection image is smoothly changed, and a very high display effect is achieved.

Further, when a particular projection position is determined, as shown in FIG. 3, a line-of-sight direction (i.e., a direction indicated by the dashed arrow) of the viewer viewing warning object may be simulated in accordance with the positional relationship between the vehicle and the warning object. The position of the line of sight passing through the projection area is the projection position.

Finally, the projection unit projects the first image and the second image onto the projection position in the projection area in accordance with the determined parallax, such that the user can observe the image of the warning information in the vicinity of the warning object.

As an example, referring the projection effect shown in FIG. 5, the driving assistance device of some embodiments of the present disclosure may display a warning image 51 of a schematic navigation direction at the left turn of the road ahead of the user's vehicle, display a warning image 52 of a driving speed of another vehicle ahead of the user's vehicle at such vehicle ahead, or display a warning image 53 of a reminder content presented on a reminder board ahead of the user’ vehicle at the reminder board.

It can be known from the projection effect shown in FIG. 5 that the driver can more intuitively determine the warning information on the position of the warning object, and compared with the display technology, there is a significant improvement in the user experience.

On the other hand, some embodiments of the present disclosure further provides a driving assistance method applied in a vehicle, which includes the following steps:

identifying a warning object ahead of the vehicle, and a positional relationship between the warning object and the vehicle (step 1);

determining warning information corresponding to the warning object, and generating a projection image in accordance with the warning information (step 2);

determining a projection position of the projection image in a projection area and a perceived distance between a formed image projected by the projection image to the projection area and a viewer in the vehicle in accordance with the positional relationship between the warning object and the vehicle (step 3); and

projecting the warning information in accordance with the determined projection position and the determined perceived distance (step 4).

The driving assistance method of some embodiments of the present disclosure enhances the display effect of the image. The projection image of the warning information is integrated with the actual environment on side of the warning object outside the vehicle, such that the driver can see the corresponding warning information in the vicinity of the position of the warning object. Therefore, the display is more intuitive, thereby avoiding the attention of the driver from distracting when driving, and improving driving safety to a certain extent.

In particular, the method of some embodiments of the present disclosure can generate a stereoscopic projection image. That is, the formed image projected by the warning information includes a first image corresponding to a left eye of the driver and a second image corresponding to a right eye of the driver.

In the projection area, the projection position of the first image is different from the projection position of the second image. The driver can converge the first image recognized by the left eye and the second image recognized by the right eye using the stereoscopic glasses, such that a display image having a stereoscopic effect is formed. Compared with ordinary display, the display image of some embodiments of the present disclosure is more realistic, and the effect of user experience is better.

In particular, in some embodiments of the present disclosure, the positional relationship between the warning object and the vehicle includes a vertical distance of the warning object relative to the vehicle in a traveling direction of the vehicle.

In the process of determining the perceived distance in step 3 above, the perceived distance of the driver for a formed image projected by the warning information is particularly determined in accordance with the vertical distance. Generally, the perceived distance is proportional to the vertical distance. That is, if the warning object is farther away from the vehicle in the traveling direction of the vehicle, the perceived distance of the driver for the warning information is farther as well. On the contrary, if the warning object is closer to the vehicle in the traveling direction of the vehicle, the perceived distance of the driver for the warning information is closer as well.

Accordingly, in above step 4, a parallax between the first image and the second image projected by the projection module is particularly determined in accordance with the determined perceived distance, and then the first image and the second image are projected in accordance with the determined parallax between the first image and the second image.

The parallax between the first image and the second image is computed by an equation of

$$A = B - \frac{B \times H}{S} ,$$

wherein A is the parallax between the first image and the second image, B is a pupil distance of the driver, H is a distance between the projection area and a center of two eyes of the viewer, and S is the perceived distance.

Further, in practical application, the warning object of some embodiments of the present disclosure may include a road element (such as an exit, an entrance and a straight line of a road and the like) ahead of the vehicle and/or an object (such as pedestrians, other vehicles or the like) ahead of the vehicle.

The warning information of the road element may include navigation information of the vehicle for the road element. In a specific implementation, the navigation information may be obtained from a navigation device in some embodiments of the present disclosure. In the display effect, the navigation reminder is displayed directly on the road where the driver needs to travel, and the driver's attention may not be distracted as compared with the navigation technique in the related art. In addition, the warning information of the object ahead of the vehicle may include movement information (such as moving speed or moving direction) of the object ahead of the vehicle, and the driver can determine the movement characteristics of the object ahead of the vehicle based on the movement information, thus the driver can make a decision in advance to avoid accidents.

Obviously, the driving assistance method of some embodiments of the present disclosure corresponds to the driving assistance device described as above, and the driving assistance method of some embodiments of the present disclosure can achieve the same technical effects as those achieved by the driving assistance device.

It will be understood by those skilled in the art that embodiments of the present disclosure may be provided as a method, a device (an apparatus), or a computer program product. Accordingly, the present disclosure may take the form of a complete hardware embodiment, a complete software embodiment, or an embodiment combining the software and hardware aspects. Moreover, the present disclosure may take the form of a computer program product implemented on one or more computer-usable storage media (including but not limited to a disk storage, a read-only optical disk, an optical memory, etc.) that contain computer-usable program codes.

The present disclosure is described with reference to a flow chart and/or block diagram of a method, a device (an apparatus) and a computer program product according to the embodiments of the present disclosure. It will be appreciated that each process and/or block in flowcharts and/or block diagrams as well as a combination of processes and/or blocks in flowcharts and/or block diagrams may be implemented by computer program instructions. These computer program instructions may be provided to a processor of a general purpose computer, a dedicated computer, an embedded processor, or other programmable data processing devices to generate a machine, such that instructions generated by a processor of a computer or other programmable data processing devices produce a device for implementing the functions specified in one or more processes in a flowchart and/or one or more blocks in a block diagram.

These computer program instructions may also be stored in a computer readable memory capable of operating a computer or other programmable data processing device in a particular manner, such that instructions stored in the computer readable memory produce a product that includes an instructing device. The instructing device implements the functions specified in one or more processes in a flowchart and/or one or more blocks in a block diagram.

These computer program instructions may also be loaded onto a computer or other programmable data processing devices, such that a series of operational steps are performed on a computer or other programmable devices to produce computer-implemented processing. Thus the instructions performed on a computer or other programmable devices provide steps for implementing the functions specified in one or more processes in a flowchart and/or one or more blocks in a block diagram.

The foregoing is a particular implementation of the present disclosure, and it should be noted that several modifications and modifications may be made by those skilled in the art without departing from the principles of the present disclosure, which are considered to be within the scope of the present disclosure.

What is claimed is:

1. A driving assistance device, applied in a vehicle having a projection area, the driving assistance device comprising:
an identification module configured to identify a warning object ahead of the vehicle and a positional relationship between the warning object and the vehicle;
an application module configured to determine warning information corresponding to the warning object, and generate a projection image in accordance with the warning information;
a processing module configured to determine a projection position of the projection image in a projection area and a perceived distance between a formed image projected by the projection image to the projection area and a viewer in the vehicle, in accordance with the positional relationship between the warning object and the vehicle; and
a projection module configured to project the warning information in accordance with the determined projection position and the determined perceived distance.

2. The driving assistance device of claim 1, wherein,
an image of the warning information projected by the projection module includes: a first image corresponding to a left eye of the viewer and a second image corresponding to a right eye of the viewer, and a projection position of the first image in the projection area is different from a projection position of the second image in the projection area.

3. The driving assistance device of claim 2, further comprising:
stereoscopic glasses configured to assist the viewer to converge the first image and the second image to form a stereoscopic image.

4. The driving assistance device of claim 2, wherein,
the positional relationship between the warning object and the vehicle includes: a vertical distance of the warning object relative to the vehicle in a traveling direction of the vehicle;
the processing module determines the perceived distance of the viewer for a formed image projected by the warning information in accordance with the vertical distance, wherein the perceived distance is proportional to the vertical distance.

5. The driving assistance device of claim 3, wherein, the projection module comprises:
a computing unit configured to determine a parallax between the first image and the second image projected by the projection module in accordance with the perceived distance; and
a projection unit configured to project the warning information in accordance with the determined parallax between the first image and the second image.

6. The driving assistance device of claim 1, wherein, the processing module is further configured to simulate a line-of-sight direction of the viewer viewing warning object in accordance with the positional relationship between the vehicle and the warning object, and determine an intersection of the line-of-sight direction and the projection area as the projection position of the projection image in the projection area.

7. A driving assistance method, applied in a vehicle having a projection area, the driving assistance method comprising:
identifying a warning object ahead of the vehicle and a positional relationship between the warning object and the vehicle;
determining warning information corresponding to the warning object, and generating a projection image in accordance with the warning information;
determining a projection position of the projection image in a projection area and a perceived distance between a formed image projected by the projection image to the projection area and a viewer in the vehicle in accordance with the positional relationship between the warning object and the vehicle; and
projecting the warning information in accordance with the determined projection position and the determined perceived distance.

8. The driving assistance method of claim 7, wherein, an image formed by projecting the warning information includes: a first image corresponding to a left eye of the viewer and a second image corresponding to a right eye of the viewer, and a projection position of the first image in the projection area is different from a projection position of the second image in the projection area.

9. The driving assistance method of claim 8, wherein,
the first image and the second image are converged to form a stereoscopic image by the viewer using a pair of stereoscopic glasses.

10. The driving assistance method of claim 8, wherein,
the positional relationship between the warning object and the vehicle includes: a vertical distance of the warning object relative to the vehicle in a traveling direction of the vehicle;
determining the perceived distance of the viewer for a formed image projected by the warning information in accordance with the positional relationship between the warning object and the vehicle includes:
determining the perceived distance of the viewer for the formed image projected by the warning information in accordance with the vertical distance, wherein the perceived distance is proportional to the vertical distance.

11. The driving assistance method of claim 10, wherein, projecting the warning information in accordance with the determined projection position and the determined perceived distance includes:
determining a parallax between the first image and the second image projected by the projection module in accordance with the perceived distance; and
projecting the first image and the second image in accordance with the determined parallax between the first image and the second image.

12. The driving assistance method of claim 11, wherein,
the parallax between the first image and the second image is computed as follows:
$$A = B - \frac{B \times H}{S} ,$$
wherein, A is the parallax between the first image and the second image, B is a pupil distance of the viewer, H is a distance between the projection area and a center of two eyes of the viewer, and S is the perceived distance.

13. The driving assistance method of claim 7, wherein,
the warning object includes a road element ahead of the vehicle and/or an object ahead of the vehicle;
wherein the warning information of the road element includes navigation information of the vehicle corresponding to the road element, and the warning information of the object ahead of the vehicle includes movement information of the object ahead of the vehicle.

14. The driving assistance method of claim 7, wherein determining the projection position of the projection image in the projection area in accordance with the positional relationship between the warning object and the vehicle includes: simulating a line-of-sight direction of the viewer viewing warning object in accordance with the positional relationship between the vehicle and the warning object, and determining an intersection of the line-of-sight direction and the projection area as the projection position of the projection image in the projection area.
